(19) United States
(12) Patent Application Publication
(10) Pub. No.: US 2010/0169774 A1
(43) Pub. Date: Jul. 1, 2010

(54) Electronics apparatus, method for displaying map, and computer program

(75) Inventors: Ryunosuke Oda, Tokyo (JP); Masanao Tsutsui, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/653,572

(22) Filed: Dec. 16, 2009

(30) Foreign Application Priority Data
Dec. 26, 2008 (JP) P2008-332644

(51) Int. Cl. G06F 3/048; G06F 3/01

(52) U.S. Cl. 715/702; 715/784; 715/838

(57) ABSTRACT

An electronics apparatus includes an information storing unit that stores map data; a display unit that displays an image; a touched position detecting unit that detects a touched position on the displayed image in the display unit; and a control unit that displays a map in the display unit using the map data, wherein the control unit sets a target position in accordance with the position detected by the touched position detecting unit, and if the target position is located on the map, the control unit displays the map so that the target position is matched with a predefined position by scrolling the map, and if the target position is not located on the map, the control unit creates another map in which the target position is matched with the predefined position using the stored map data, and replaces the map displayed by the display unit with the created map.

### CROSS-REFERENCE TO RELATED APPLICATION

The present application claims priority from Japanese Patent Application No. JP 2008-332644 filed in the Japanese Patent Office on Dec. 26, 2008, the entire content of which is incorporated herein by reference.

### BACKGROUND OF THE INVENTION

1. Field of the Invention

The present invention relates to electronics apparatuses, methods for displaying a map, and computer programs. More particularly, it sets a target position in accordance with a touched position, and displays a map so that the set target position is matched with a predefined position, with the result that a user can easily display the map that shows the position the user wants to know about.

2. Description of the Related Art

In the related art, an electronic apparatus capable of displaying a map is configured in such a manner as to make it easy for a user to confirm, for example, where an image content was obtained, or where a target shop is by creating markers on the map.

In Japanese Unexamined Patent Application publication 2001-51770, an electronics apparatus where different operations are performed on the basis that an auxiliary switch is on or off when some operation is performed on a touch panel is disclosed. For example, when the auxiliary switch is off, the displayed map is scrolled in accordance with an operation performed by a user. On the other hand, when the auxiliary switch is on, the displayed map is moved in accordance with a displayed symbol that the user selects.

### SUMMARY OF THE INVENTION

For an electronic apparatus capable of displaying a map that shows a position a user wants to know about, it may be desirable that the operation of the electronics apparatus is simple.

However, in the electronics apparatus disclosed in Japanese Unexamined Patent Application publication 2001-51770, there is a problem that it is not easy to display a map that shows a position a user want to look for by a simple operation because the user has to perform not only the operation on the touch panel but also the operation of the auxiliary switch.

Therefore, the present invention provides an electronic apparatus capable of displaying a map that shows a position a user wants to look for by a simple operation by the user, a method for displaying images used therefor, and a computer program used therefor.

An electronics apparatus according to an embodiment of the present invention includes an information storing unit that stores map data; a display unit that displays an image; a touched position detecting unit that detects a touched position on the displayed image in the display unit; and a control unit that displays a map in the display unit using the map data. Furthermore, the control unit sets a target position in accordance with the position detected by the touched position detecting unit, and if the target position is located on the map displayed by the display unit, the control unit displays the map so that the target position is matched with a predefined position by scrolling the map; and if the target position is not located on the map displayed by the display unit, the control unit creates another map in which the target position is matched with the predefined position using the stored map data, and replaces the map displayed by the display unit with the created map.

In this embodiment of the present invention, a marker is created on the map. And if, after either the touched position or the marker is set as a reference, the other is inside a predefined area based on the reference, the position of the marker is set as the target position, and if the other is not inside the predefined area based on the reference, a position on the map corresponding to the detected position is set as the target position.

In addition, if a plurality of markers are inside a predefined area based on the detected position set as a reference, or if a plurality of markers are such that the detected position is inside a predefined area based on each marker set as a reference, the position of a marker with the highest priority is set as the target position after determining priorities for individual markers on the basis of attribute information of individual markers.

A plurality of thumbnails are displayed, and if the touched position is a position where a thumbnail is displayed, the thumbnail is moved in accordance with the touched position, and a position corresponding to the thumbnail displayed at the predefined position is set as a target position. Here, if the target position is located on the displayed map, the map is scrolled so that the target position is matched with the center position of the area in which the map is displayed. In addition, if the target position is not located on the map displayed by the display unit, another map in which the target position is matched with the predefined position is created using the stored map data, and the currently displayed map is replaced with the created map.

A method for displaying a map according to an embodiment of the present invention includes the step of detecting a touched position on a displayed image in a display unit that displays an image with the use of a touched position detecting unit; the step of setting a target position in accordance with the position detected by the touched position detecting unit with the use of a control unit; the step of displaying a map so that the target position is matched with a predefined position by scrolling the map if the target position is located on the map displayed by the display unit with the use of the control unit; and the step of creating another map in which the target position is matched with the predefined position using stored map data if the target position is not located on the displayed map, and replacing the map displayed by the display unit with the created map with the use of the control unit.

A computer program according to an embodiment of the present invention makes a computer function as setting means that, when a touched position on a displayed image in the display unit that displays an image is detected by a touched position detecting unit, sets a target position in accordance with the detected position; display means that, if the target position is located on the map displayed by the display unit, displays the map so that the target position is matched with a predefined position by scrolling the map; and replacing means that, if the target position is not located on the displayed map, creates another map in which the target position is matched with the predefined position using the stored map data, and replaces the currently displayed map with the created map.

In addition, the computer program according to the embodiment of the present invention is a computer program provided in computer readable formats via storage media such as an optical disk, a magnetic disk, a semiconductor memory, or via communication media such as a network. In addition, the above readable formats are formats commonly used by general-purpose computers that can execute various kinds of program codes. In this way the computer program according to the above-described embodiment of the present invention is provided in computer readable formats, so that various processes in accordance with the computer program can be realized on a computer system.

According to the present invention, a target position is set in accordance with a detected position, and if the target position is located on the displayed map, the map is scrolled and displayed so that the target position is matched with a predefined position. If the target position is not located on the displayed map, another map is created in which the target position is matched with the predefined position using the stored map data, and the map displayed by the display unit is replaced with the created map. Therefore, a user can easily display the map that shows a position the user wants to look for.

### BRIEF DESCRIPTION OF THE DRAWINGS

FIG. 1 is a block diagram showing a configuration of an image capture apparatus in the case where the electronics apparatus is the image capture apparatus;

FIG. 2 is a diagram showing a configuration of a file system;

FIGS. 3A to 3D show examples of a display screen;

FIG. 4 is a flowchart showing the behavior of a control unit when a touch panel event occurs;

FIG. 5 is a flowchart showing processing of an event inside a map area;

FIG. 6 is a flowchart showing marker appointment judgment;

FIG. 7 is a diagram showing an example of a judgment database;

FIGS. 8A and 8B show examples of the shapes of a content marker and a selection region;

FIGS. 9A and 9B show the relation between a touched position and the display position of a marker;

FIGS. 10A to 10B are diagrams to explain a scroll operation;

FIG. 11 is a flowchart showing a single scroll operation;

FIG. 12 is a flowchart showing a single operation performed using a remaining distance;

FIG. 13 is an example of an image displayed in a map area (when a position displaced from displayed content markers is touched);

FIG. 14 is an example of an image displayed on a map area (when the position of one of displayed content markers is touched);

FIG. 15 is an example of an image displayed on a map area (when a touched position detecting unit continues to be pushed);

FIG. 16 is a flowchart showing processing of an event outside a map area;

FIG. 17 is a diagram showing another configuration of a content selection area;

FIGS. 18A to 18D are diagrams showing an example of a content forward/backward operation;

FIGS. 19A to 19D are diagrams showing another example of a content forward/backward operation; and

FIG. 20 is a block diagram showing a configuration example of a computer apparatus.

### DESCRIPTION OF THE PREFERRED EMBODIMENT

The preferred embodiments of the present invention will be described hereinafter. The following items are described in this order.

1. The configuration of an electronics apparatus according to an embodiment of the present invention

2. The behavior of the electronics apparatus

3. The configurations of other electronics apparatuses according to other embodiments of the present invention

### <1. The Configuration of an Electronics Apparatus According to an Embodiment of the Present Invention>

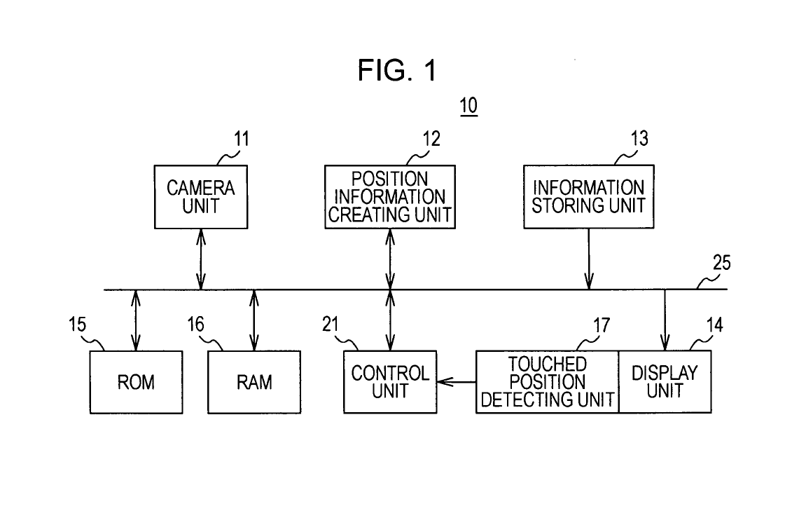

Under the assumption that an electronics apparatus according to an embodiment of the present invention is an image capture apparatus, FIG. 1 is a block diagram showing a configuration of the image capture apparatus. The electronics apparatus stores image data obtained from captured images as content data. A camera unit 11 of an image capture apparatus 10 includes an optical system block, an image capture device, a signal processing circuit, and the like. The optical system block includes a lens, a zoom mechanism, and the like, and focuses an optical image of an object on the imaging area of the image capture device. For example, a CMOS (complementary metal oxide semiconductor) type image sensor or a CCD (charge coupled device) is used as the image capture device. The image capture device generates an image signal corresponding to an optical image by performing photoelectric conversion, and outputs the image signal to the signal processing circuit. The signal processing circuit converts the image signal fed from the image capture device into a digital signal, and performs various kinds of signal processing on the digital signal. For example, image development processing, color calibration, resolution conversion, compression/decompression processing, and the like are performed as necessary.

A position information generating unit 12 includes, for example, a GPS (global positioning system) module. The GPS module includes an antenna unit that receives GPS radio waves, a signal conversion unit that converts the received radio waves into electronic signals, a calculating unit that calculates position information, and the like. The position information generating unit 12 generates position information regarding the position of the image capture apparatus 10 (latitude, longitude, and the like).

An information storing unit 13 is a recording medium such as a nonvolatile memory, an optical disk, or a hard disk device. The information storing unit 13 stores the image data generated by the camera unit 11, attribute information that shows the position information generated by the position information generating unit 12 and the like. In addition, the information storing unit 13 stores map data that are used for displaying a map.

A display unit 14 is a liquid crystal display devices or the like, and displays an image on the basis of the image data output by the camera unit 11. The display unit 14 also displays an image on the basis of the image data stored in the information storing unit 13, and displays a map using the map data stored in the information storing unit 13. In addition, the display unit 14 displays various menus and the like.

A ROM 15 stores a program that runs the image capture apparatus 10. A RAM 16 is a working memory that temporarily stores data.

A touched position detecting unit 17 detects a touched position on the image displayed by the display unit 14. The touched position detecting unit 17 generates a touched position signal that shows a position touched by a user, and feeds the signal to a control unit 21. If the touched position detecting unit 17 includes a touch panel, the touch panel is installed on the display screen of the display unit 14. The touch panel generates a touched position signal that indicates a panel coordinate (hereinafter called a panel coordinate for short) corresponding to the position touched by a user when the user touches the touch panel, and feeds the signal to the control unit 21. Alternatively, the touched position detecting unit 17 can be configured to generate a signal that shows a position selected by the user with the use of a pointing device such as a mouse.

The control unit 21 is connected to the above-described units via a bus 25. The image capture apparatus starts when the control unit 21 reads out a program stored in the ROM 15 and executes the program. In addition, the control unit 21 judges what kind of operation is performed by the user on the basis of the image displayed by the display unit 14 and the touched position signal fed by the touched position detecting unit 17. The control unit 21 controls each unit of the image capture apparatus 10 on the basis of the judgment result, and makes each unit run in accordance with the operation performed by the user.

In addition, the control unit 21 sets a target position in accordance with the position detected by the touched position detecting unit 17. If the target position is located on the map displayed by the display unit 14, the control unit 21 scrolls and displays the map so that the target position is matched with a predefined position, for example, to the center position of the map area in which the map is displayed by the display unit 14. In other words, the control unit 21 performs a scroll process using the map data stored in the RAM 16, and makes the display unit 14 display a map that is in the middle of the scroll operation, a map that has already been scrolled, or the like. If the target position is not located on the map displayed by the display unit 14, the control unit 21 reads out the map data from the information storing unit 13, and creates another map in which the target position is matched with the predefined position using the map data. In addition, the control unit 21 makes the RAM 16 store image data of the created map, with the result that the map displayed by the display unit 14 is replaced with the newly created map.

In the electronics apparatus configured as described above, in order to make the image data and the attribute information stored in the information storing unit 13 available in other apparatuses, it is necessary that, after image files are created from the image data and the attribute information in accordance with prevailing rules, a file system, which is created using the image files, is stored in the information storing unit 13. For example, some ways to realize this are as follows:

Create image files from image data and attribute data in accordance with Exif (exchangeable image file format) standard.

Create a file system using DCF (design rule for camera file system) standard, and store the file system in the information storing unit 13.

Alternatively, a file system can be configured when image files are stored in the information storing unit 13 so that desired image data or attribute information is easily retrievable.

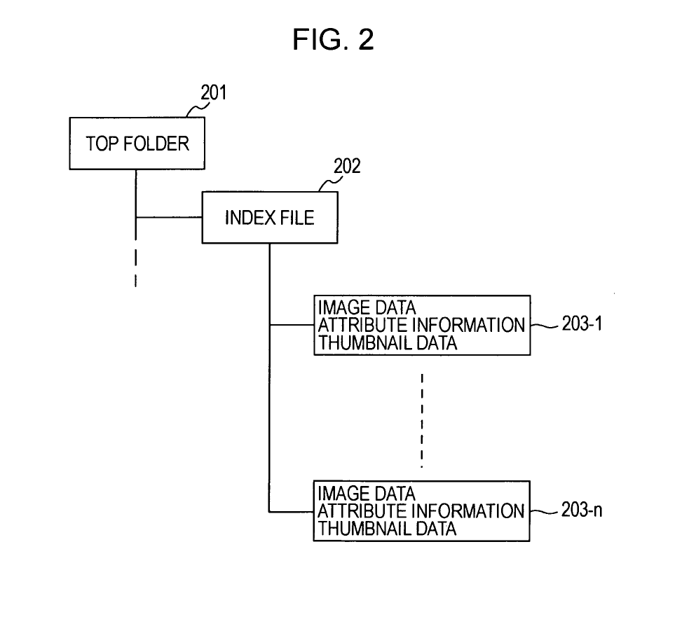

FIG. 2 is a diagram showing a configuration of a file system. Image files are stored in a folder (top folder). The top folder 201 is configured to store an index file 202 that is used to manage the image files. The index file 202 includes image files 203-1 to 203-n that individually accommodate image data, attribute information, thumbnails, and the like. The folder name of the top folder 201 and the file names of the image files 203-1 to 203-n can be configured to be specified by a user. Alternatively, they can be configured to be automatically specified. For example, the file names can be automatically configured to be specified using the current time, position information, or the like.

The index file 202 stores management information that makes it possible to retrieve desired image data and attribute information. The management information is information that relates the names of the stored image files 203-1 to 203-n, and/or IDs, attribute information for the image files, and the like to each other. Here, the attribute information is information about shooting dates and times, position information, the number of faces, facial expressions and the like shown in captured images.

Therefore, the control unit 21 can easily retrieve desired image files using the management information stored in the index file 202. Alternatively, the image files 203-1 to 203-n can be stored in the top folder 210 instead of being stored in the index file 202. If the index file 202 is not prepared, the control unit 21 can retrieve the desired image files by reading out necessary information from individual image files.

### <2. The Behavior of the Electronics Apparatus>

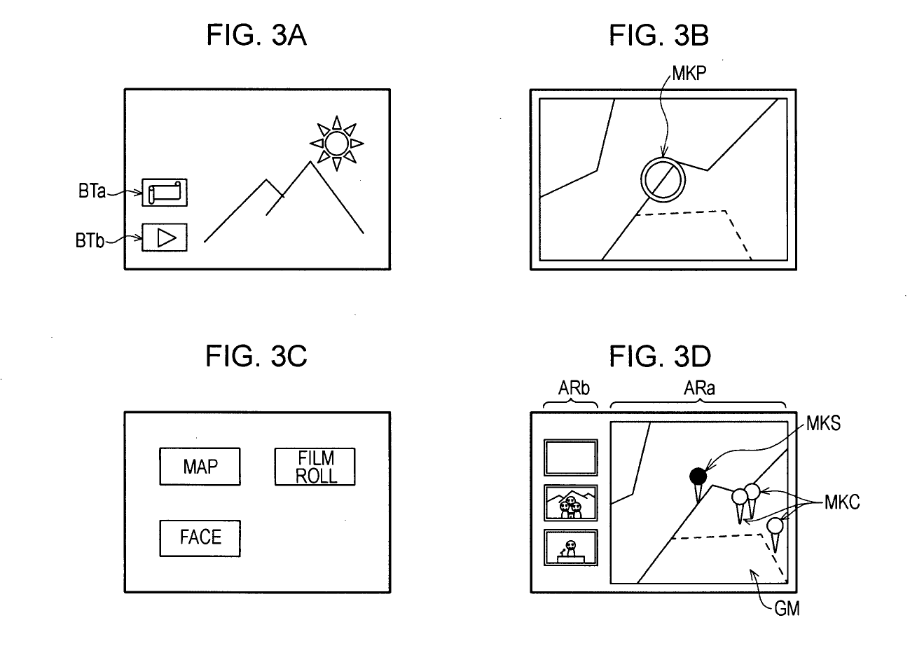

Next, the behavior of the electronics apparatus will be described. FIGS. 3A to 3D show display screens of the electronics apparatus—such as the image capture apparatus 10 shown in FIG. 1.

The control unit 21 displays an image capture mode screen as shown in FIG. 3A when the electronics apparatus starts to run in the image capture mode. The control unit 21 makes the display unit 14 display a camera image using image data being generated in the camera unit 11. In addition, the control unit 21 creates button displays of a current position button BTa and a regeneration button BTb on the camera image. The current position button BTa is used to replace the currently displayed image screen with a current position screen that shows the current position of the image capture apparatus 10 on a map. The regeneration button BTb is used to replace the currently displayed image screen with a view selection screen where a kind of regeneration to be performed is selected.

If the panel coordinate that is indicated by the touched position signal fed from the touched position detecting unit 17 is inside the display area of the current position button BTa, the control unit 21 replaces the image capture mode screen with the current position screen shown in FIG. 3B. The control unit 21 obtains position information that shows the current position from the position information generating unit 12. Next, the control unit 21 obtains map data from the information storing unit 13 on the basis of the obtained position information, creates a map in which the current position is matched with the center position of the map area of the display unit 14 on the basis of the obtained map data, and makes the display unit 14 display the created map. In addition, the control unit 21 creates a current position marker MKP that shows the current position on the created map.

If the panel coordinate that indicates the touched position fed from the touched position detecting unit 17 is inside the display area of the regeneration button BTb, the control unit 21 replaces the image capture mode screen with the view selection screen shown in FIG. 3C.

When the view selection screen is displayed, the control unit 21 judges in which button display area the touched position is located on the basis of the panel coordinate indicated by the touched position signal fed from the touched position detecting unit 17. Then, if the touched position is located inside the display area of a map index screen display button “MAP”, the control unit 21 replaces the view selection screen with a map index screen shown in FIG. 3D.

There are a map area ARa and a content selection area ARb on the map index screen. The map area ARa is an area that shows a map image GM, content markers MKC, and a selected marker MKS showing a selected content. The content selection area ARb is an area that shows a predefined number of thumbnails of image files stored in the information storing unit 13. Here, the content markers MKC, the selected marker MKS, and the current position marker MKP only have to have functions of indicating positions, and being represented by predefined drawings, images, characters, icons, and the like, they are used by a user.

The control unit 21 determines priorities for the image files stored in the information storing unit 13 on the basis of the predefined attributes of the image files or the attributes desired by the user, and displays the thumbnails of the image files in the content selection area ARb in descending order of determined priority. For example, if three thumbnails can be displayed in the content selection area ARb as shown in FIG. 3D, the control unit 21 displays the thumbnail of the image file with the highest priority in the center area. Next, the thumbnail of the image file with the second highest priority is displayed in the lower thumbnail area.

In addition, the control unit 21 relates the thumbnails displayed in the content selection area ARb to the displays in the map area ARa, and displays a map in accordance with a thumbnail displayed in the content selection area ARb. For example, the control unit 21 obtains position information from attribute information corresponding to a thumbnail displayed in the center area, and displays the map so that the position shown by the obtained position information is matched with the center position of the map area ARa. In addition, the control unit 21 judges whether image data that have been generated by capturing images inside the area of the map displayed on the map area ARa are stored in the information storing unit 13 or not on the basis of the attribute information. If the image data that have been generated by picking up images inside the area of the displayed map are stored, the control unit 21 creates content markers MKC in the image capture position.

In addition, when the map index screen is displayed, the control unit 21 controls the display of a map or the like in accordance with the operation performed by the user.

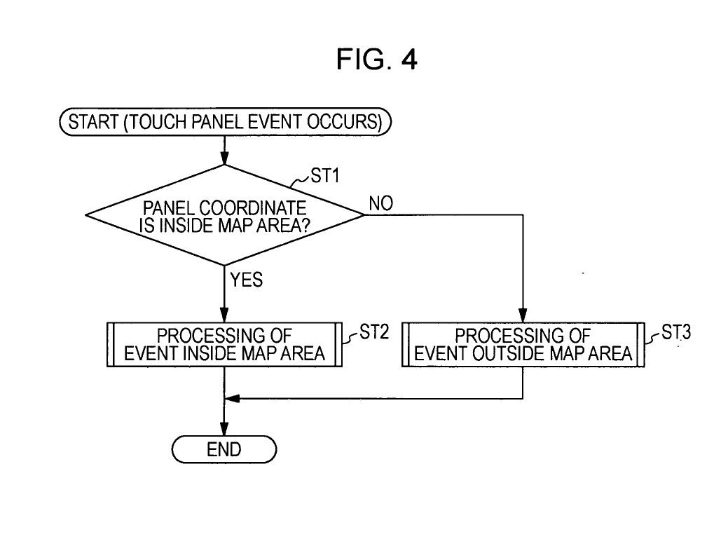

FIG. 4 is a flowchart showing the behavior of the control unit 21 when a touch panel event occurs due to operation of the touched position detecting unit 17. The control unit 21 judges whether a panel coordinate corresponding to the touched position is inside the map area ARa or not at step ST1 when the touch panel event occurs. The control unit 21 obtains a panel coordinate that is indicated by a touched position signal fed from the touched position detecting unit 17 when operation of the touched position detecting unit 17 is performed. If the obtained panel coordinate is inside the map area ARa, that is, if the touched position is on the map, the flow of the behavior of the control unit 21 proceeds to step ST2 and the control unit 21 performs processing of the event inside the map area. If the obtained panel coordinate is not inside the map area ARa, that is, if the touched position is inside the content selection area ARb, the flow proceeds to step ST3 and the control unit 21 performs processing of the event outside the map area.

### [Processing of an Event Inside a Map Area]

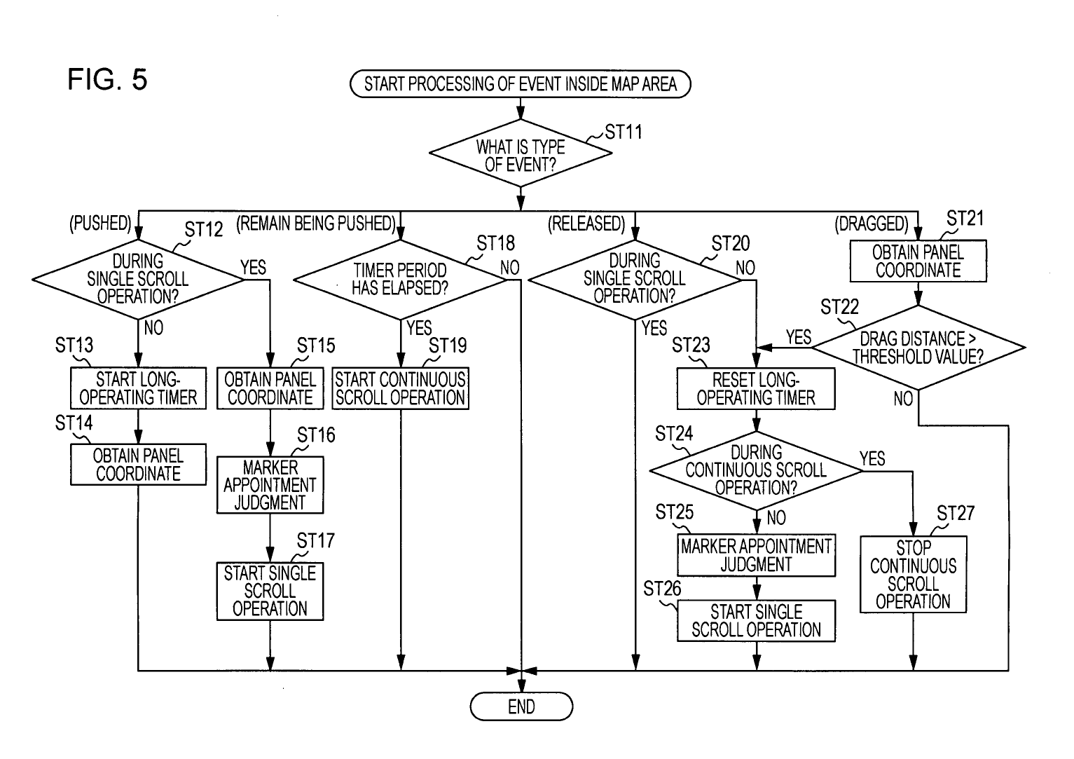

FIG. 5 is a flowchart showing processing of an event inside a map area. At step ST11, the control unit 21 judges the type of an event. The flow proceeds to step ST12 when the touched position detecting unit 17 is pushed. The flow proceeds to step ST18 when the touched position detecting unit remains being pushed, and proceeds to step ST20 when the touched position detecting unit 17 is released from the state of being pushed. In addition, the flow proceeds to step ST21 when the touched position detecting unit 17 remains being pushed and at the same time the pushed position is moved, that is, when a dragging operation is performed on the touched position detecting unit 17, the flow proceeds to step ST21.

The flow proceeds to step ST12 when the touched position detecting unit 17 is pushed, and then the control unit 21 judges whether a single scroll operation is being performed or not. The single scroll operation is an operation by which a map is scrolled so that a target position created in accordance with a touched position is matched with a predefined position such as the center position of the map area ARa. A continuous scroll operation, which will be described hereinafter, is an operation by which a map is scrolled from the center position of a map area ARa to a touched position during an operation period.

The flow proceeds to step ST13 when the control unit judges that the single scroll operation is not being performed, and proceeds to step ST15 when the control unit 21 judges that the single scroll operation is being performed.

At step ST13, the control unit 21 makes a long-operating timer start, and the flow proceeds to step ST14. The long-operating timer is a timer used to judge whether to start a continuous scroll operation or not.

At step ST14, the control unit 21 obtains a panel coordinate corresponding to the touched position. To put it concretely, the control unit 21 obtains a panel coordinate shown by a touched position signal fed from the touched position detecting unit 17, and finishes the processing of the event judged at step ST11.

The flow proceeds to step ST15 after the control unit 21 judges that the single scroll operation is being performed at step ST12, and the control unit 21 obtains a panel coordinate corresponding to the touched position. Then the control unit 21 obtains a panel coordinate shown by a touched position signal fed from the touched position detecting unit 17, and the flow proceeds to step ST16.

At step ST16, the control unit 21 performs marker appointment judgment. The control unit 21 detects content markers displayed in the vicinity of the panel coordinate obtained at step ST15, and creates a target position on the basis of the detected result. Then the flow proceeds to step ST17. The detail of the marker appointment judgment will be described later.

At step ST17, the control unit 21 starts a single scroll operation. The control unit 21 start to scroll the map so that the target position determined at step ST16 is matched with the center position of the map area ARa, and finishes the processing of the event judged at step ST11. The detail of the single scroll operation will be described later.

The flow proceeds to step ST18 from step ST11 when the touched position detecting unit 17 remains being pushed, and at step ST18 the control unit 21 judges whether a timer period of the long-operating timer has elapsed or not. When the control unit 21 judges that an operation continuation period, that is, a period during which the touched position detecting unit 17 remains being pushed since the long-operating timer starts at step ST13, has exceeded the timer period set by the long-operating timer, the flow proceeds to step ST19. If the operation continuation period does not exceeds the timer period, the control unit 21 finishes the processing of the event judged at step ST11.

At step ST19, the control unit 21 starts a continuous scroll operation. The control unit 21 starts to scroll the map from the center position of the map area ARa to the panel coordinate obtained at step ST14, and finishes the processing of the event judged at step ST11.

The flow proceeds to step ST20 from step ST11 when the touched position detecting unit 17 is released from the state of being pushed, and the control unit 21 judges whether a single scroll operation is being performed or not. If the single scroll operation is being performed, the control unit 21 finishes the processing of the event judged at step ST11. If the single scroll operation is not being performed, the flow proceeds to step ST23.

The flow proceeds from step ST11 to step ST21 when the dragging operation is performed on the touched position detecting unit 17, and then the control unit 21 obtains a panel coordinate. To put it concretely, the control unit 21 obtains the panel coordinate shown by a touched position signal fed from the touched position detecting unit 17, and then the flow proceeds to step ST22.

At step ST22, the control unit 21 judges whether the moving distance of the touched position (drag distance) is larger than a predefined threshold value or not. If the moving distance is not larger than the threshold value, the control unit 21 finishes the processing of the event judged at step ST11. If the drag distance is larger than the threshold value, the flow proceeds to step ST23.

At step ST23, the control unit 21 resets the long-operating timer. Because the touched position detecting unit 17 is released from the state of being pushed or because the drag operation with the drag distance larger than the threshold value is performed, the control unit 21 resets the long-operating timer used to judge whether to start a continuous scroll operation or not, and then the flow proceeds to step ST24.

At step ST24, the control unit 21 judges whether the continuous scroll operation is being performed or not. The flow proceeds to step ST25 when the control unit 21 judges that the continuous scroll operation is not being performed, and proceeds to step ST27 when the control unit 21 judges that the continuous scroll operation is being performed.

At step ST25, the control unit 21 performs marker appointment judgment in a same way as at step ST16, and then the flow proceeds to step ST26.

At step ST26, the control unit 21 starts a single scroll operation. The control unit 21 scrolls the map so that the target position determined at step ST25 is matched with the center position of the map area ARa, and finishes the processing of the event judged at step ST11.

At step ST27, the control unit 21 stops the continuous scroll operation, and finishes the processing of the event judged at step ST11.

### [Marker Appointment Judgment]

Marker appointment judgment will be described below. In marker appointment judgment, if, after either the touched position or a displayed marker is set as a reference, the other is inside a predefined area based on the reference, the position of the marker is set as a target position. If the other is not inside the predefined area, a position on the map corresponding to the detected position is set as the target position. The case where the predefined area is determined on the basis of the touched position set as a reference will be described below.

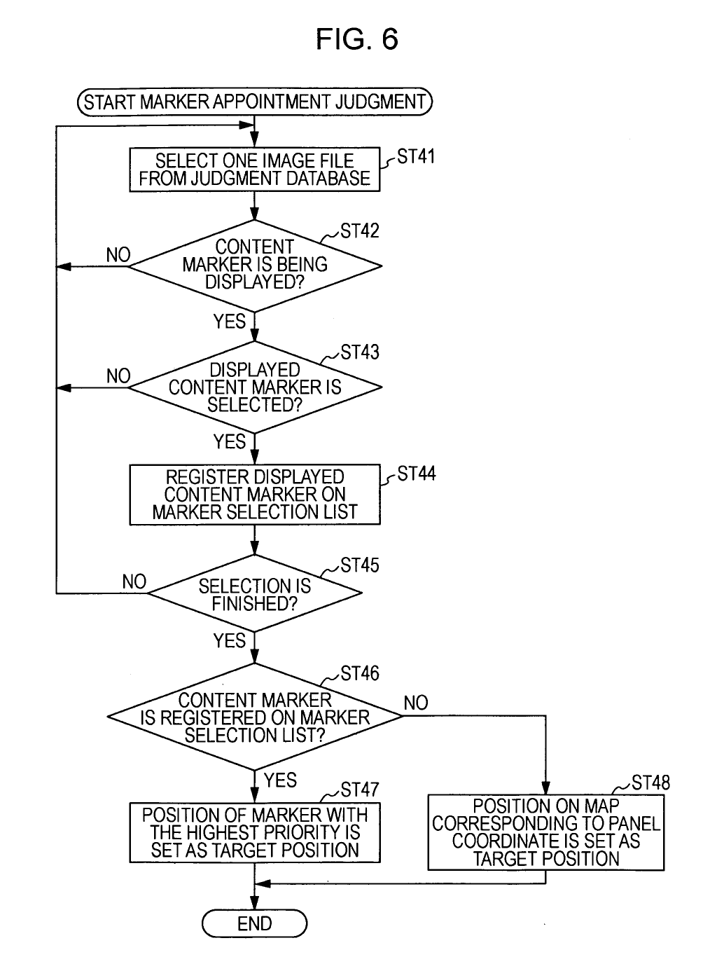

FIG. 6 is a flowchart showing marker appointment judgment. In marker appointment judgment, information for each image file is read out from a prepared judgment database, and then content markers displayed in the vicinity of the obtained panel coordinate are detected.

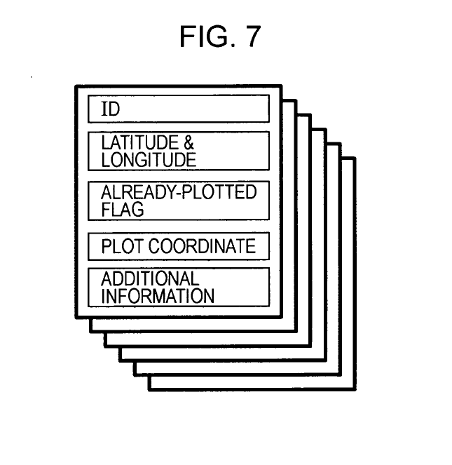

FIG. 7 shows an example of a judgment database. In the judgment database, data base items such as “ID”, “LATITUDE & LONGITUDE”, “ALREADY-PLOTTED FLAG”, “PLOT COORDINATE”, “ADDITIONAL INFORMATION” are prepared. The item “ID” is unique information prepared for each image file to identify the image file. The item “LATITUDE & LONGITUDE” is position information showing an image capture position where an image datum was captured. The item “ALREADY-PLOTTED FLAG” is a flag showing whether content markers are displayed on a map or not. The item “PLOT COORDINATE” is information that shows the coordinate of a displayed content marker when the content marker is displayed. The item “ADDITIONAL INFORMATION” stores, for example, attribute information used to determine priorities for image files, and the like. Attribute information includes dates and times when contents are created, the number of persons obtained from facial recognition performed for each content, facial expressions, image capture mode and the like.

If the index file 202 is prepared as shown in FIG. 2, the judgment database is created using management information of the index file 202. Because the index file 202 includes attribute information about image files 203-1 to 203-n and the like, the judgment database can be easily created without reading out attribute information and the like from each image file. If the index file 202 is not prepared, the judgment database can be created by sequentially reading out attribute information and the like from the image files 203-1 to 203-n.

The judgment database is used in processing of an event inside a map area, and information about “ALREADY-PLOTTED FLAG” and “PLOT COORDINATE” is updated in accordance with the map scrolling. Therefore, it may be convenient to store the judgment database, for example, on the RAM 16.

At step ST41, the control unit 21 selects one image file from the judgment database, extracts information about the selected image file, and then the flow proceeds to step ST42.

At step ST42, the control unit 21 judges whether content markers corresponding to the selected image file are being displayed or not. When the extracted “ALREADY-PLOTTED FLAG” shows that the content markers are not being displayed, the flow goes back to step ST41, and then the control unit 21 selects another image file that has not been selected yet from the judgment database and extracts information about the selected image file. When the extracted “ALREADY-PLOTTED FLAG” shows that a content markers is being displayed, the flow proceeds to step ST43.

At step ST43, the control unit 21 judges whether any one of the displayed content markers is selected or not. To put it concretely, the control unit 21 defines a selection region so that the center of the selection region is matched with the panel coordinate obtained when the operation is performed on the touched position detecting unit 17, and judges whether any one of the displayed content markers is included inside the selection region or not.

When any one content marker is not included inside the selection region, the flow goes back to step ST41, and then the control unit 21 selects another image file that has not been selected yet from the judgment database and extracts information about the selected image file. When some displayed content marker is included inside the selection region, the control unit 21 judges that the displayed content marker is selected by a user, and the flow proceeds to step ST44.

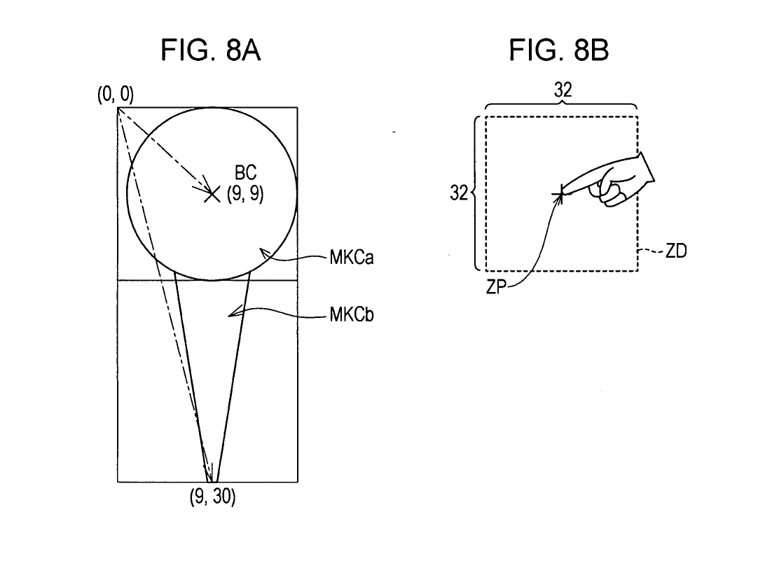

FIGS. 8A and 8B show examples of the shapes of a content marker and a selection region. FIG. 8A shows a content marker MKC. The content marker includes a body MKCa and a position indicating part MKCb. Here, let's suppose that the body MKCa of the content marker MKC is a circle with its center BC located at the coordinate (9, 9) and its radius of 9 under the assumption that the upper left corner of the rectangular shown in FIG. 8A is the origin of the coordination system. In addition, let's suppose that the position indicating part MKCb of the content marker MKC is a wedge protruding from the lower part of the body MKCa and the edge of the position indicating part MKCb is displaced “21” from the center BC of the body MKCa. The edge of the position indicating part MKCb shows the position of the content on the map.

FIG. 8B shows a selection region ZD, which is assumed to be a rectangular region with its center located at the panel coordinate ZP that shows the touched position. It is also assumed that each side of the selection region ZD is long. In FIG. 8A and FIG. 8B, the numeric values representing the radius and the lengths are “the number of pixels”. The number of pixels of the display unit 14 is, for example, 720×480. In addition, it may be possible that the sizes of the content marker MKC and the selection region ZD can be optimally set in accordance with the number of pixels and the size of the display unit 14 and the like.

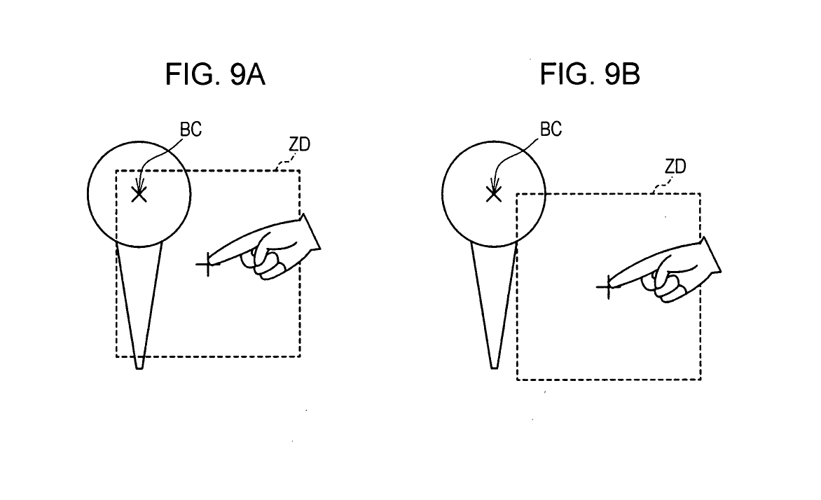

FIGS. 9A and 9B show the relation between a touched position and the display position of a marker. The control unit 21 defines a selection region ZD so that the center of the selection region is matched with a panel coordinate ZP indicated by the touched position signal fed from the touched position detecting unit 17. If the center BC of the body MKCa of the content marker MKC is inside the selection region ZD as shown in FIG. 9A, the control unit 21 judges that the displayed content marker is selected by a user. If the center BC of the body MKCa of the content marker MKC is outside the selection region ZD as shown in FIG. 9B, the control unit 21 judges that the displayed content marker is not selected by the user.

At step ST44, the control unit 21 registers the content marker MKC, which is judged to be selected, on the marker selection list, and then the flow proceeds to step ST45.

At step ST45, the control unit 21 judges whether all the image files registered in the judgment database have selected or not. If there are image files that have not been selected yet, the flow goes back to step ST41. The control unit 21 selects one of the image files that have not been selected yet, and extracts information about the selected image file. Then the flow proceeds from step ST41 to step ST45 through step ST43 and Step ST44. The above-described procedures are repeated until all the image files registered in the judgment database are selected. When all the image files registered in the judgment database have been selected, the flow proceeds to step ST46.

At step ST46, the control unit 21 judges whether a content marker MKC is registered on the marker selection list or not. If the content marker MKC is registered on the marker selection list, the flow proceeds to step ST47, and if the content marker MKC is not registered on the marker selection list, the flow proceeds to step ST48.

At step ST47, the control unit 21 sets a marker MKC with the highest priority as a target position Pm. The target position Pm is a position that is matched with the center position of a map area ARa by scrolling a map. If only one content marker MKC is registered on the marker selection list, the control unit 21 set a position indicated by the position information of the attribute information corresponding to this content marker MKC as the target position Pm, and finishes this marker appointment judgment.

At step ST47, if plural content markers MKC are registered on the marker selection list, the control unit 21 identifies a content marker MKC with the highest priority. To put it concretely, the control unit 21 judges priorities for the markers MKC registered on the marker selection list using attribute information corresponding to each content marker, and identifies the content marker MKC with the highest priority. The priority can be set using information desired by the user such as attribute information including information about shooting dates and times, the number of faces, facial expressions and the like. The control unit 21 sets a position indicated by the position information of the image file corresponding to the identified content marker MKC as the target position Pm, and finishes this marker appointment judgment. In addition, the control unit 21 converts the content marker set as the target position to a selected marker to distinguish it from other content markers.

At step ST48, the control unit 21 sets a position on the map corresponding to the panel coordinate ZP as the target position Pm, and finishes the marker appointment judgment. In other words, the control unit 21 identifies the panel coordinate ZP, that is, a position on the map corresponding to the touched position, and sets this position on the map corresponding to the touched position as the target position Pm, and finishes the marker appointment judgment.

### [Scroll Operation]

The scroll operation will be described below. A single scroll operation is an operation by which a map is scrolled so that the target position Pm is matched with the center position of the map area ARa. A continuous scroll operation is an operation by which a map is scrolled from the start time of the scroll operation to the time when the touched position detecting unit 17 is released from the state of being pushed, while maps in the middle of the scroll operation (called intermediate images hereinafter) are displayed one by one. In the display step of the intermediate images, the update time interval is of the intermediate images and the moving distance Ms of an intermediate image are set beforehand.

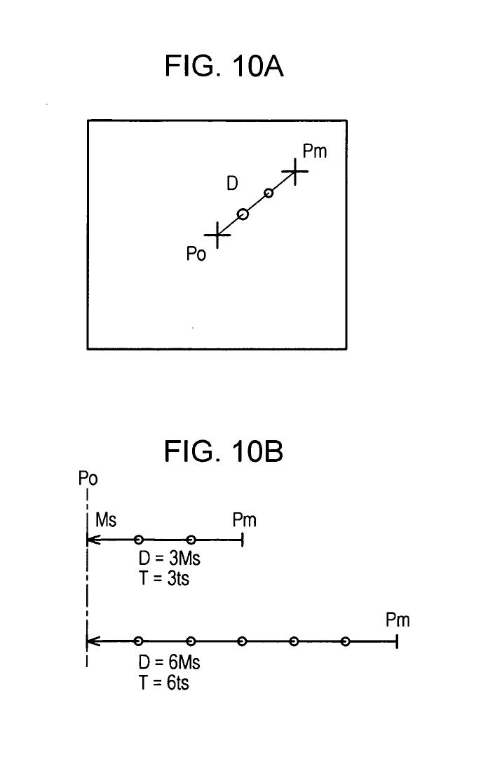

FIGS. 10A and 10B are diagrams to explain the scroll operation. In the case of a single scroll operation, assuming that the distance between a target position Pm and the center position Po of a map area ARa is D as shown in FIG. 10A and FIG. 10B, a map with the target position Pm being matched with a position shown by a mark ◯ is displayed as an intermediate map during the scroll operation. The time period T between the start of the scroll operation to the end is given by the equation “T=D/Ms×ts”.

In the case of a continuous scroll operation, assuming that the time period between the start of the continuous scroll operation to the time when the touched position detecting unit 17 is released from the state of being pushed is “Tp”, a moving distance Dp is given by the equation “Dp=Tp/ts×Ms”. Therefore, the map is moved in accordance with the time period while the touched position detecting unit 17 is pushed. Therefore, because the moving distance can be intuitively determined by recognizing the time period while the touched position detecting unit 17 is pushed, even a remote position can be easily reached. In addition, if the update time interval ts and the unit moving distance Ms are changed in accordance with the distance between the touched position of the touched position detecting unit 17 and the center position Po of the map area ARa, the desired position can be effectively reached. For example, if the distance between the touched position of the touched position detecting unit 17 and the center position Po of the map area ARa is short, the unit moving distance Ms is set short, and if the distance is long, the unit moving distance Ms is set long. In this way, if a user wants to move the map to a remote position, the map can be swiftly scrolled to the remote position by pushing a position remote from the center position Po.

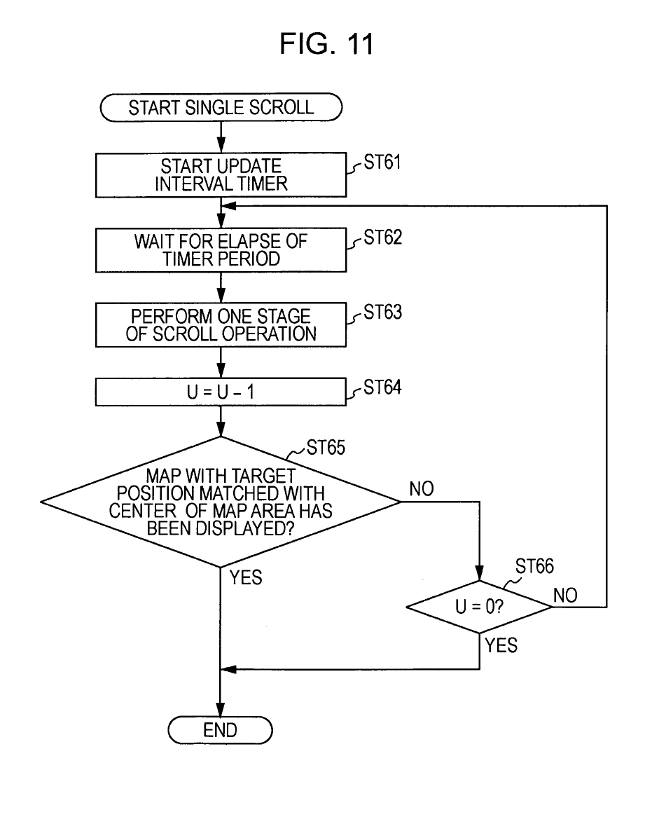

FIG. 11 is a flowchart showing a single scroll operation. The control unit 21 sets the number of scroll stages using the distance between a target position Pm and the center position Po of a map area ARa, and a unit moving distance Ms at the start of the single scroll operation. For example, the number of scroll stages U is set so that it meets the conditional equation “(U−1)×Ms≦D<U×Ms”.

At step ST61, the control unit 21 starts an update interval timer, and the flow proceeds to step ST62.

At step ST62, the control unit 21 waits for the elapse of the timer period of the update interval timer. When the timer period of the update interval timer elapses, the flow proceeds to step ST63.

At step ST63, the control unit 21 performs one stage of scroll operation. The control unit 21 creates an intermediate image by moving the center position of the currently displayed map no more than the unit moving distance Ms, and performs one stage of scroll operation by replacing the currently displayed map with the newly created intermediate image, and then the flow proceeds to step ST64.

At step ST64, the control unit 21 subtracts “1” from the number of scroll stages U, and substitutes the result for U, and then the flow proceeds to step ST65.

At step ST65, the control unit 21 judges whether a map with the target position Pm being matched with the center position Po of the map area ARa is completed or not. If the above-mentioned map is not completed, the flow proceeds to step ST66, and if completed, the single scroll operation is finished.

At step ST66, if the number of scroll stages is not “0”, the control unit 21 resets the update interval timer and the flow goes back to step ST62. If the number of scroll stages is “0”, the single scroll operation is finished.

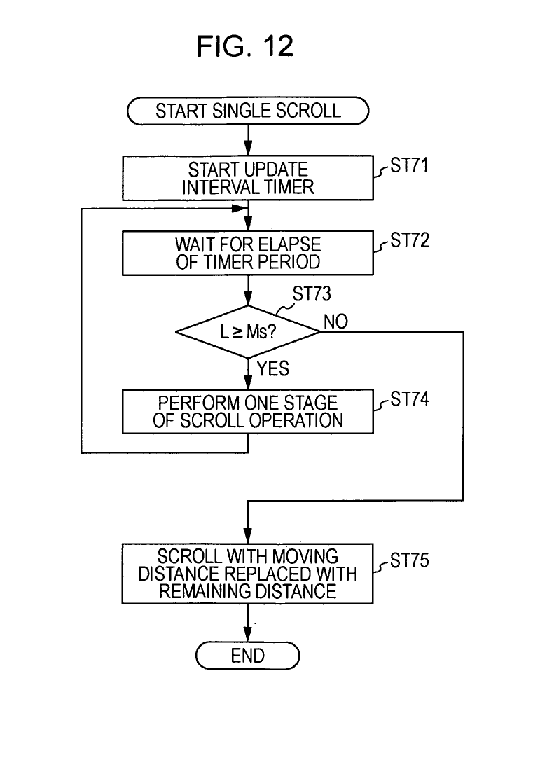

In the above-mentioned single scroll operation shown in FIG. 11, the number of scroll stages U is used to perform the single scroll operation, a single scroll operation can be also performed using a remaining distance L from the target position to the center position Po of the map area ARa. FIG. 12 is a flowchart showing a single operation performed using a remaining distance.

At step ST71, the control unit 21 starts an update interval timer, and the flow proceeds to step ST72.

At step ST72, the control unit 21 waits for the elapse of the timer period of the update interval timer. When the timer period of the update interval timer elapses, the flow proceeds to step ST73.

At step ST73, the control unit 21 judges whether the remaining distance L is equal to or larger than the unit moving distance Ms or not. If the remaining distance L is equal to or larger than the unit moving distance Ms, the flow proceeds to step ST74. If the remaining distance is smaller than the unit moving distance Ms, the flow proceeds to step ST75.

At step ST74, the control unit 21 performs one stage of scroll operation. To put it concretely, the control unit 21 creates an intermediate image by moving the center position of the currently displayed map no more than the unit moving distance Ms, and performs one stage of scroll operation by replacing the currently displayed map with the newly created intermediate image. Then the control unit 21 resets the update interval timer, and the flow goes back to step ST72.

The remaining distance L shortens by the moving distance Ms every time the process at step ST74 is performed. When the remaining distance L finally becomes shorter than the moving distance Ms, the flow proceeds from step ST73 to step ST75.

At step 75, the control unit 21 performs a scroll operation with the moving distance Ms replaced with the remaining distance L. In other words, the control unit 21 moves the target position Pm to the center position Po of the map area ARa no longer than the remaining distance L, with the result that a map with the target position Pm matched with the center position Po of the map area ARa is displayed, and then the control unit 21 finishes the single scroll operation.

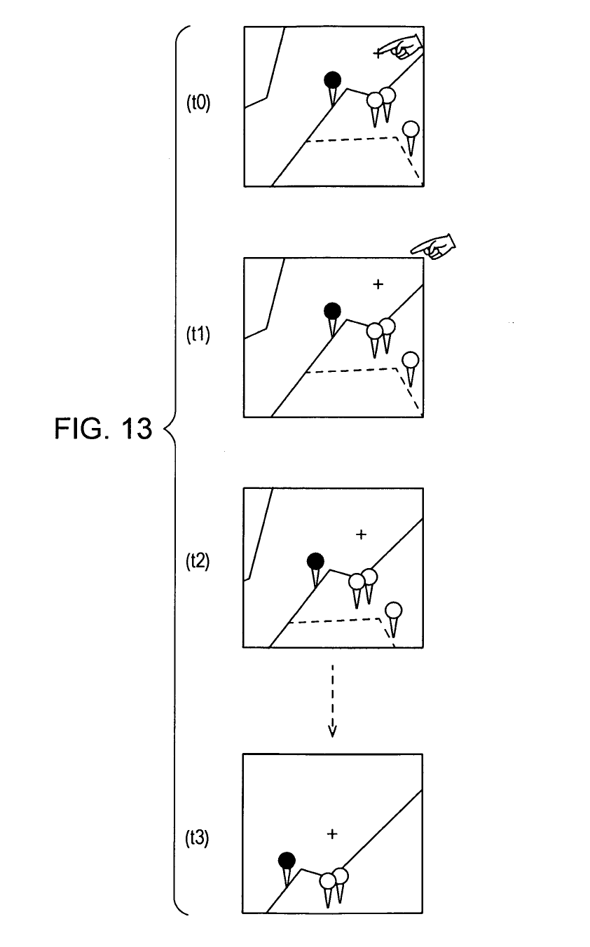

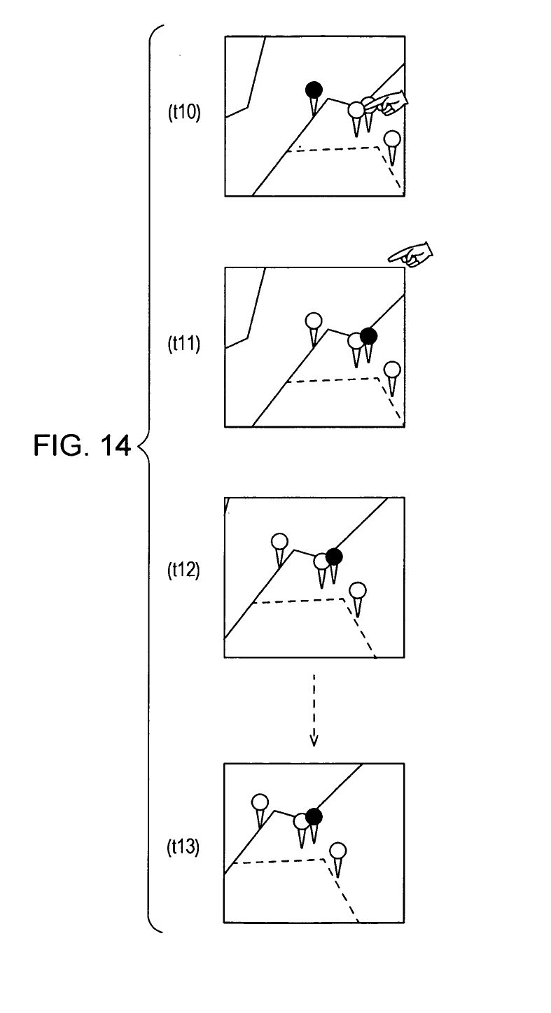

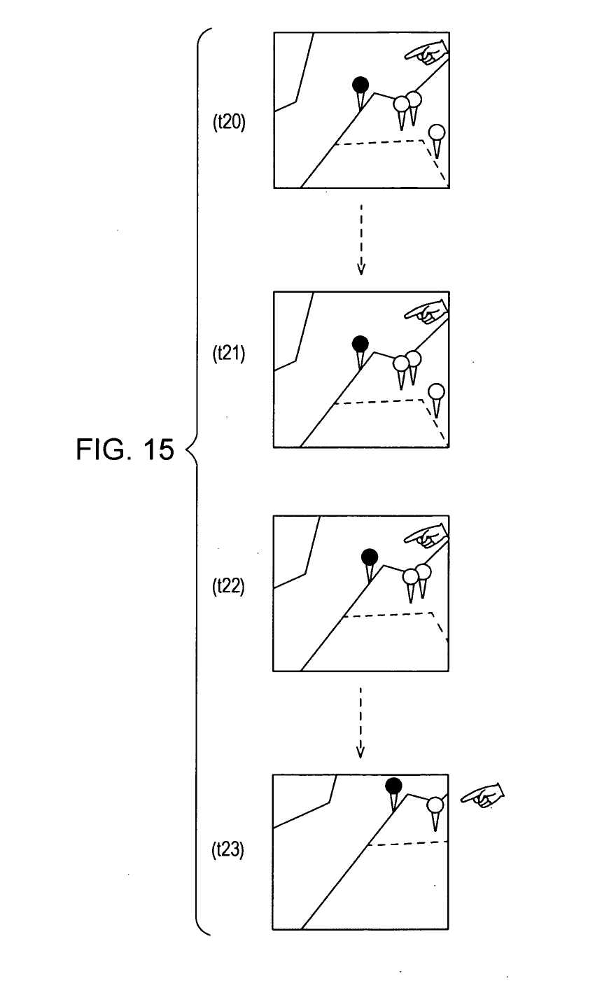

FIG. 13, FIG. 14, and FIG. 15 show examples of images displayed in the map area ARa when touched positions are inside the map area ARa. FIG. 13 is an example of an image displayed when a position displaced from displayed content markers is touched. FIG. 14 is an example of an image displayed when the position of one of displayed content markers is touched. FIG. 15 is an example of an image displayed when the touched position detecting unit 17 continues to be pushed.

As shown in FIG. 13, if a position displaced from displayed content markers in the map area ARa is pushed at the time t0, for example, by a finger when a scroll operation is not being performed, the control unit 21 performs processes of step ST12, step ST13, and step ST14 shown in FIG. 5. If the finger leaves from the position at the time t1 before the elapse of the timer period of the long-operating timer, the control unit 21 performs step ST20, step ST23, step ST24, and step ST25 because the scroll operation is not being performed. Because there is no content marker in the vicinity of the touched position when marker appointment judgment is performed at step ST25, the control unit 21 sets the position on the map (shown by the mark +in FIG. 13) corresponding to the panel coordinate ZP that shows the touched position as a target position at step ST 48 in FIG. 6. Then the control unit 21 starts a single scroll operation at step ST26 shown in FIG. 5. Afterward, the control unit 21 displays a map in the middle of the single scroll operation, for example, at the time t2 as shown in FIG. 13. The control unit 21 finishes the single scroll operation when the target position is matched with the center position of the map area ARa at the time t3.

As described above, if a position in the map area ARa is pushed during the period shorter than the timer period of the long-operating timer and there is no content marker in the vicinity of the touched position, a single scroll operation that matches the touched position with the center position of the map area ARa is automatically performed.

As shown in FIG. 14, if a position in the vicinity of content markers in the map area ARa is pushed at the time t10, for example, by a finger when a scroll operation is not being performed, the control unit 21 performs the processes of step ST12, step ST13, and step ST14 shown in FIG. 5. If the finger leaves from the position at the time t11 before the elapse of the timer period of the long-operating timer, the control unit 21 performs step ST20, step ST23, step ST24, and step ST25 because the scroll operation is not being performed. Because there is the content marker in the vicinity of the touched position when marker appointment judgment is performed at step ST25, the control unit 21 sets the position on the map shown by a marker with the highest priority as a target position at step ST 47 in FIG. 6. In addition, the control unit 21 replaces the display of the above content marker with the display of the selected marker (for example, with the display of a marker with its body daubed) to distinguish it from other content markers. Then the control unit 21 starts a single scroll operation at step ST26 shown in FIG. 5. Afterward, the control unit 21 displays a map in the middle of the single scroll operation, for example, at the time t12 as shown in FIG. 14. The control unit 21 finishes the single scroll operation when the target position, that is, the position shown by the selected marker, is matched with the center position of the map area ARa at the time t13.

As described above, if a position in the map area ARa is pushed during the period shorter than the timer period of the long-operating timer and there are some content markers in the vicinity of the touched position, a marker with highest priority of these markers is selected and set as a selected marker. In addition, a single scroll operation that matches the position shown by the selected marker with the center position of the map area ARa is automatically performed. Therefore, the map with the position of a desired content marker matched with the center position of the map area ARa can be easily displayed.

As shown in FIG. 15, if a position in the map area ARa of the touched position detecting unit 17 is pushed at the time t20, for example, by a finger when a scroll operation is not being performed, the control unit 21 performs the processes of step ST12, step ST13, and step ST14 shown in FIG. 5. And then if the touched position detecting unit 17 continues to be pushed until the time t21 when the timer period of the long-operating timer elapses, the control unit performs the process of step ST19. In other words, it starts a continuous scroll operation. Afterward, the control unit 21 displays a map in the middle of the continuous scroll operation, for example, at the time t22 as shown in FIG. 15. If the finger leaves from the position in the map area ARa of the touched position detecting unit 17 at the time t23, the control unit 21 performs step ST20, step ST23, step ST24, and step ST27, and finishes the continuous scroll operation.

As described above, if the position in the map area ARa continues to be pushed longer than the timer period of the long-operating timer, the continuous scroll operation are automatically performed in the direction from the center position of the map area ARa to the touched position. Therefore, even in the case where a desired position is not shown in a displayed map, a desired position can be easily displayed inside the map area ARa because a continuous scroll operation is performed by continuously pushing a position in the map area ARa.

Although it is not shown as an example of an image as shown in FIG. 13, FIG. 14, or FIG. 15, if a position in the map area ARa is pushed during a single scroll operation, the processes of step ST12, step ST 15, step ST16, and step ST17 are performed, and a single scroll operation in accordance with the new touched position is automatically performed. In addition, if a drag operation in which its drag distance is larger than a threshold value is performed, the control unit 21 performs the processes of step ST23 and step ST24, and then performs the processes of step ST25 and step ST26, or the process of step ST27 as shown in FIG. 5. Therefore, by performing a drag operation, a user can set a new target position and start a new single operation, or the user can finish a continuous scroll operation that is being performed.

### [Processing of an Event Outside a Map Area]

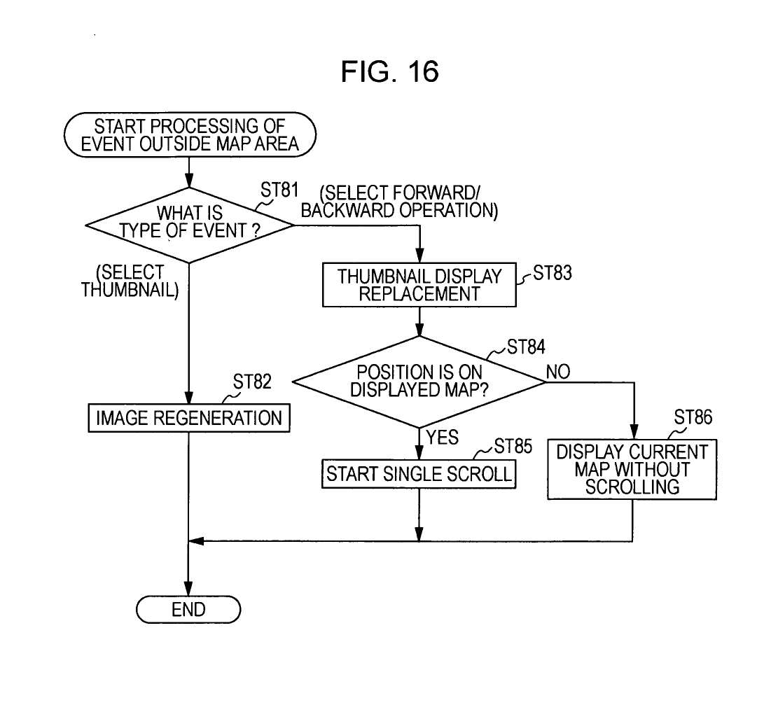

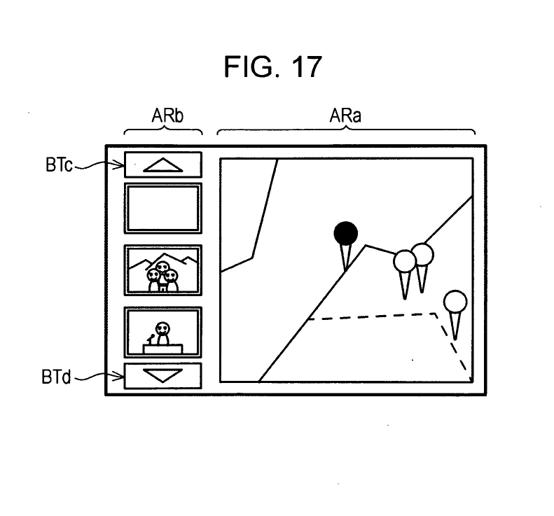

Processing of an event outside a map area will be described with reference to a flowchart shown in FIG. 16. At step ST81, the control unit 21 judges the type of event. The flow proceeds to step ST82 when an operation to select a content displayed in a content selection area is performed. The flow proceeds to step ST83 when a content forward/backward operation on a content displayed in the content selection area is performed. For example, as shown in FIG. 3D, let's prepare three thumbnail areas in the content selection area ARb, and set the middle thumbnail area as a content selecting operation area, the upper thumbnail area as a content backward operation area, and the lower thumbnail area as a content forward operation area. In addition, as shown in FIG. 17, the button displays for a forward button BTc to perform a content forward operation and a backward button BTd to perform a content backward operation can be individually prepared in the content selection area ARb. The following description will be given under the assumption that the upper thumbnail area is a content backward operation area and the lower thumbnail area is a content forward operation.

The control unit 21 obtains a panel coordinate ZP shown by a touched position signal fed from the touched position detecting unit 17, and if the obtained panel coordinate ZP is located in the middle thumbnail area, the flow proceeds to step ST82. If the obtained panel coordinate ZP is located in the upper or lower thumbnail area, the flow proceeds to step ST83.

At step ST82, the control unit 21 regenerates an image. The control unit 21 reads out image data corresponding to a thumbnail displayed in the middle thumbnail area from the information storing unit 13. Furthermore, the control unit 21 replaces a map index screen with a content regeneration screen in the screen display of the display unit 14, and displays an image on the basis of the readout image data.

At step ST83, the control unit 21 performs thumbnail display replacement. If the obtained panel coordinate ZP is located in the lower thumbnail area, the control unit judges that a content forward operation is performed, and moves a thumbnail in the middle thumbnail area to the upper thumbnail area, and a thumbnail in the lower thumbnail area to the middle thumbnail area. In addition, the control unit 21 displays a thumbnail of an image file, which priority is next to the priority of the image file corresponding to the thumbnail displayed in the middle thumbnail area, in the lower thumbnail area. Then the flow proceeds to step ST84. If the obtained panel coordinate ZP is located in the upper thumbnail area, the control unit judges that a content backward operation is performed, and moves the thumbnail in the middle thumbnail area to the lower thumbnail area, and the thumbnail in the upper thumbnail area to the middle thumbnail area. In addition, the control unit 21 displays a thumbnail of an image file, which priority is higher than the priority of the image file corresponding to the thumbnail displayed in the middle thumbnail area, in the upper thumbnail area. Then the flow proceeds to step ST84.

At step ST84, the control unit 21 obtains position information of an image file corresponding to a thumbnail displayed in the middle thumbnail area. The control unit 21 judges whether a position shown by the obtained position information is on the displayed map or not.

If the position is on the displayed map, the flow proceeds to step ST85. If the position is not on the displayed map, the flow proceeds to step ST86.

At step ST85, the control unit 21 starts a single scroll operation. The control unit 21 sets the position shown by the position information of the image file corresponding to the thumbnail displayed in the middle thumbnail area as a target position, and scrolls the map so that the target position is matched with the center position of the map area ARa. Because the position corresponding to the thumbnail displayed in the middle thumbnail area is set as the target position, the control unit 21 changes the content marker that shows the thumbnail in the middle thumbnail area to a selection marker.

At step ST86, the control unit 21 performs map replacement processing. The control unit 21 sets the position shown by the position information of the image file corresponding to the thumbnail displayed in the middle thumbnail area as a target position. The control unit 21 continues to display the current map without scrolling it until it becomes possible to display a new map in which the target position is matched with the center position of the map area ARa. Afterward, when the new map in which the target position is matched with the center position of the map area ARa becomes ready to display, the control unit 21 replaces the current map with the new map to display the new map.

In addition, the processes of step ST84 to step ST86 can be applied to the case where the current position is displayed. For example, in the case where the display of a map index screen is replaced with the display of the current position screen, the control unit 21 judges whether the current position is located inside the area of the currently displayed map or not. If the current position is located on the currently displayed map, the control unit 21 scrolls the currently displayed map so that the current position is matched with the center position of the map area ARa by performing a single scroll operation. If the current position is not located on the currently displayed map, the control unit 21 continues to display the currently displayed map without scrolling it until it becomes possible to display a new map in which the current position is matched with the center position of the map area ARa. Afterward, when the new map becomes ready to display, the control unit 21 replaces the current displayed map with the new map to display the new map.

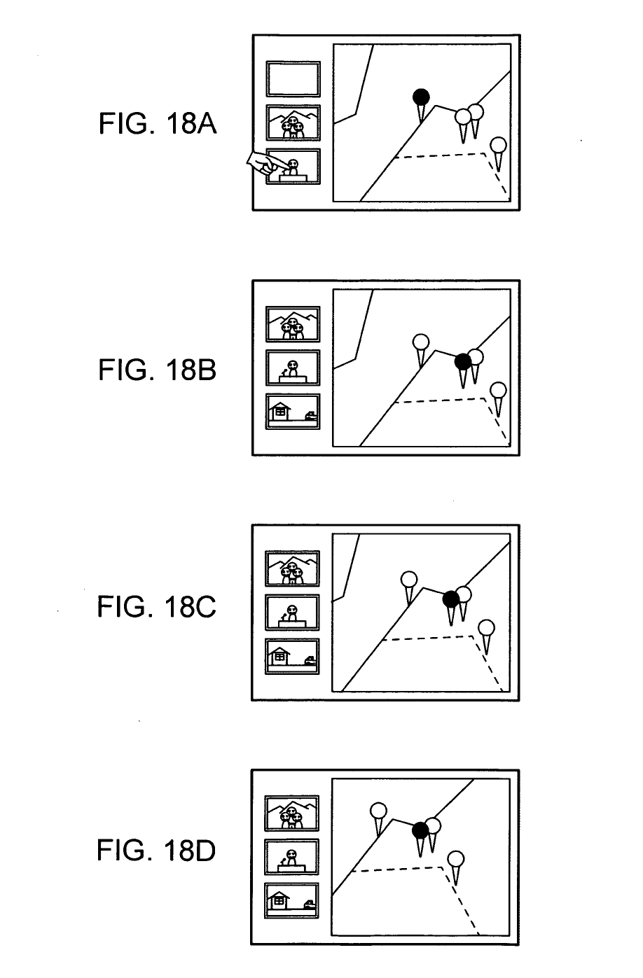

FIGS. 18A to 18D show examples of a content forward/backward operation. As shown in FIG. 18A, if the position of a thumbnail in the lower thumbnail area of the content selection area ARb is pushed, for example, by a finger and then released from the state of being pushed, the control unit 21 performs a content forward operation. To put it concretely, the control unit 21 moves a thumbnail in the middle thumbnail area to the upper thumbnail area, and a thumbnail in the lower thumbnail area to the middle thumbnail area as shown in FIG. 8B. In addition, the control unit 21 displays a thumbnail of an image file which priority is next to the priority of the image file corresponding to the thumbnail displayed in the lower thumbnail area.

In addition, because the content forward/backward operation is selected, the control unit 21 performs the process of step ST83 in FIG. 16. The control unit 21 judges whether the position shown by the position information of the attribute information corresponding to a thumbnail newly displayed in the middle thumbnail area is located on the displayed map or not. If the position corresponding to the thumbnail is located on the displayed map, a content marker is displayed at the position corresponding to the thumbnail. Therefore, the control unit 21 replaces the display of the content marker corresponding to the thumbnail newly displayed in the middle thumbnail area with the display of a selected marker, and starts a single scroll operation at step ST85. Furthermore, the control unit 21 changes the display of the former selected marker used before the content forward/backward operation into the display of a content marker.

After stating the single scroll operation, the control unit 21 displays an intermediate image as shown in FIG. 18C, and finishes the single scroll operation when the position shown by the selected marker is matched with the center position of the map area ARa as shown in FIG. 18D.

In addition, although it is no shown, if the position of a thumbnail in the upper area in the content selection area ARb is pushed, for example, by a finger and then released from the state of being pushed, the control unit performs a content backward operation. To put it concretely, the control unit 21 moves a thumbnail in the middle thumbnail area to the lower thumbnail area, and a thumbnail in the upper thumbnail area to the middle thumbnail area.

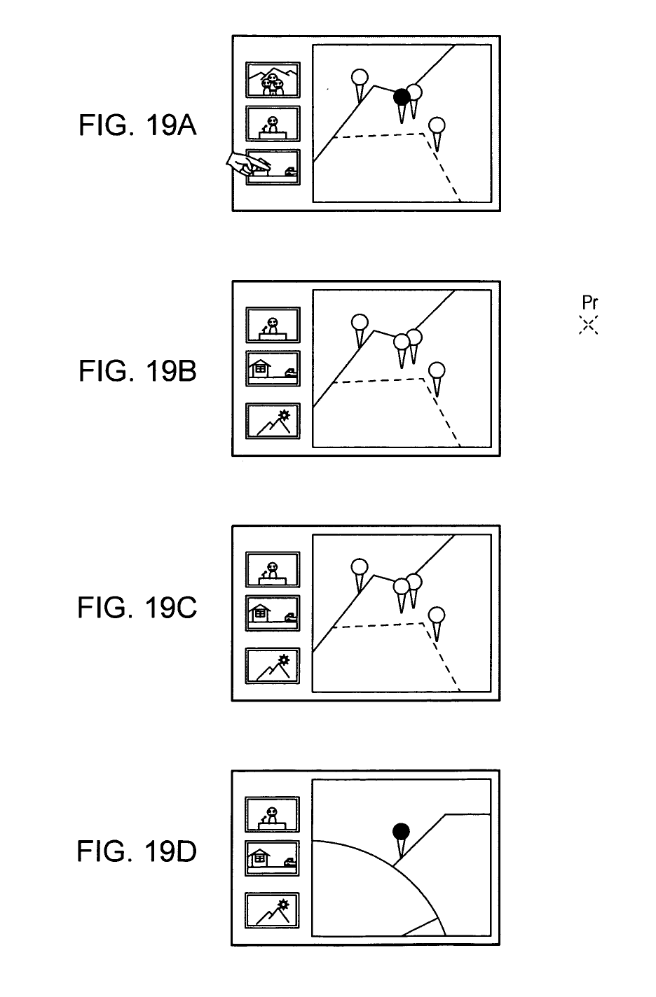

FIGS. 19A to 19D show another example of a content forward/backward operation. As shown in FIG. 19A, if the position of a thumbnail in the lower thumbnail area of the content selection area ARb is pushed, for example, by a finger and then released from the state of being pushed, the control unit 21 performs a content forward operation. To put it concretely, the control unit 21 moves a thumbnail in the middle thumbnail area to the upper thumbnail area, and a thumbnail in the lower thumbnail area to the middle thumbnail area as shown in FIG. 19B. In addition, the control unit 21 displays a thumbnail of an image file, which priority is next to the priority of the image file corresponding to the thumbnail displayed in the lower thumbnail area, in the lower thumbnail area.

In addition, because the content forward/backward operation is selected, the control unit 21 performs the process of step ST83 in FIG. 16. The control unit 21 judges whether the position shown by the position information of the attribute information corresponding to a thumbnail newly displayed in the middle thumbnail area is located on the displayed map or not. Here, if the position shown by the position information is the position Pr that is not located on the displayed map as shown in FIG. 19B, the control unit 21 performs the process of step ST86 in FIG. 16. Furthermore, the control unit 21 changes the display of the former selected marker used before the content forward/backward operation into the display of a content marker because the content forward/backward operation has been selected.

As shown in FIG. 19C, the control unit 21 continues to display the map image displayed when the content forward/backward operation is started without scrolling it. Afterward, when the new map, in which the position corresponding to the thumbnail newly displayed in the middle thumbnail area is matched with the center position of the map area ARa and the selected marker is set at the center position, becomes ready to display, the control unit 21 replaces the current displayed map with the new map. In this case, as shown in FIG. 19D, the map, in which the position corresponding to the thumbnail newly displayed in the middle thumbnail area is matched with the center position of the map area ARa and the selected marker is set at the center position, is displayed.

As described above, by performing a forward operation or a backward operation on a selected thumbnail displayed in a content selection area ARb, a map in which an image capture position, that is, a position where an image datum corresponding to the selected thumbnail was captured, is matched with the center position of the map area ARa can be automatically displayed. Furthermore, because the content marker corresponding to the selected thumbnail is automatically changed to a selected marker, the marker corresponding to the selected thumbnail can be easily identified.

### <3. The Configurations of Other Electronics Apparatuses According to Other Embodiments of the Present Invention>

In the above embodiment of the present invention, the descriptions have been made for the case where the electronics apparatus to which the present invention is applied is an image capture apparatus, but the present invention may be applied not only to image capture apparatuses but also to various apparatuses as long as they have a function to display a map. For example, the present invention may be applied to a navigation apparatus, a mobile phone, and the like. In the case of a navigation apparatus, marks showing, for example, stores and various facilities can be displayed using data about the stores and facilities as content data. Furthermore, a computer apparatus that executes a series of above-described processes using programs—such as a personal computer, a server computer, or the like—can be also considered an electronics apparatus to which the present invention can be applied. In the computer apparatus, image data obtained from captured images, data about shops and various facilities can be used as content data in a similar way to the image capture apparatus or the navigation apparatus.

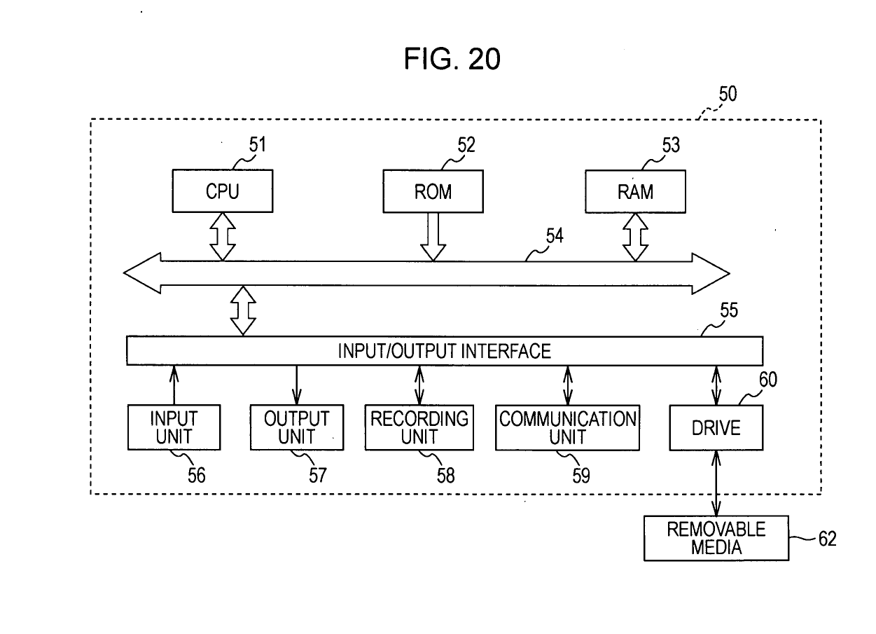

FIG. 20 is a block diagram showing a configuration example of a computer apparatus that executes a series of above-described processes using programs. A CPU 51 of a computer apparatus 50 performs various processes according to computer programs that are temporarily or permanently stored in a ROM 52 or a recording unit 58.

A RAM 53 stores computer programs, various data, and the like that the CPU 51 executes if necessary. These CPU 51, ROM 52, and RAM 53 are connected to each other via a bus 54.

An input/output interface 55 is also connected to the CPU 51 via the bus 54. An input unit 56 composed of a touch panel, a keyboard, a mouse, and a microphone, and an output unit 57 composed of a display and a speaker are connected to the input/output interface 55. The CPU 51 executes various processes in accordance with instructions issued from the input unit 56. Then CPU 51 sends the results of the processes to the output unit 57.

The recording unit 58 connected to the input/output interface 55 is composed of, for example, hard disks, and stores the computer programs and various data that the CPU 51 executes. A communication unit 59 communicates with external apparatuses via wire and wireless communication media such as the Internet, local area networks, digital broadcasts and the like. Furthermore, the computer apparatus 50 can obtain computer programs via the communication unit 59, and can record them in the ROM 52 or the recording unit 58.

A drive 60 drives an installed removable medium such as a magnetic disk, an optical disk, a magneto-optical disk, a semiconductor memory, or the like, and obtains computer programs, data, and the like recorded in the removable medium. The obtained computer programs and data are transferred to the ROM 52, the RAM 53, or the recording unit 58 if necessary.

The CPU 51 reads out computer programs used to perform the above-described series of processes, and executes them, with the result that a map that shows a position a user wants to look for can be easily displayed. For example, a map that shows a position the user wants to look for can be displayed at the output unit 57 in accordance with a touched position specified by the user at the input unit 56.

It should be understood that the present invention is not interpreted in a limited way by the above-described embodiments of the present invention. The above-described embodiments of the present invention have been disclosed as preferred examples of the present invention. Therefore, it will be obvious to those skilled in the art that various modifications and alternations may be made without departing from the scope of the present invention. In other words, the scope of the present invention is to be determined with reference to the following claims.

What is claimed is:

1. An electronics apparatus comprising:
an information storing unit that stores map data;
a display unit that displays an image;
a touched position detecting unit that detects a touched position on the displayed image in the display unit; and
a control unit that displays a map in the display unit using the map data,
wherein
the control unit sets a target position in accordance with the position detected by the touched position detecting unit, and
if the target position is located on the map displayed by the display unit, the control unit displays the map so that the target position is matched with a predefined position by scrolling the map; and
if the target position is not located on the map displayed by the display unit, the control unit creates another map in which the target position is matched with the predefined position using the stored map data, and replaces the map displayed by the display unit with the created map.

2. The electronics apparatus according to claim 1, wherein
the control unit creates a marker on the map, and
if, after either the touched position or the marker is set as a reference, the other is inside a predefined area based on the reference, the control unit sets the position of the marker as the target position, and
if the other is not inside the predefined area based on the reference, the control unit sets a position on the map corresponding to the detected position as a target position.

3. The electronics apparatus according to claim 2, wherein,
if a plurality of markers are inside a predefined area based on the detected position set as a reference, or if a plurality of markers are such that the detected position is inside a predefined area based on each marker set as a reference, the position of a marker with the highest priority is set as the target position after determining priorities for individual markers on the basis of attribute information of individual markers.

4. The electronics apparatus according to claim 2, wherein,
if the operation is continuously performed longer than a predefined period of time, the map is continuously scrolled from the predefined position to the touched position.

5. The electronics apparatus according to claim 2, wherein
the marker that shows the set target position is replaced with a marker distinguishable from other markers.

6. The electronics apparatus according to claim 2, wherein
a plurality of thumbnails are displayed, and a position corresponding to the thumbnail displayed in a predefined area is set as the target position.

7. The electronics apparatus according to claim 6, wherein
the marker that shows the position corresponding to the thumbnail displayed in the predefined area is displayed in a different way to be distinguished from other markers.

8. The electronics apparatus according to claim 1, wherein
the period of time during which the map image is scrolled is determined in accordance with the distance from the target position to the predefined position.

9. The electronics apparatus according to claim 1, wherein
the predefined position is the center position of the area in which the map is displayed.

10. A method for displaying a map, comprising the steps of:
detecting a touched position on a displayed image in a display unit that displays an image with the use of a touched position detecting unit;
setting a target position in accordance with the position detected by the touched position detecting unit with the use of a control unit;
displaying a map so that the target position is matched with a predefined position by scrolling the map if the target position is located on the map displayed by the display unit with the use of the control unit; and
creating another map in which the target position is matched with the predefined position using stored map data if the target position is not located on the displayed map, and replacing the map displayed by the display unit with the created map with the use of the control unit.

11. A computer program that makes a computer function as:
functional means that, when a touched position on a displayed image in the display unit that displays an image is detected by a touched position detecting unit, sets a target position in accordance with the detected position;
functional means that, if the target position is located on the map displayed by the display unit, displays the map so that the target position is matched with a predefined position by scrolling the map; and
functional means that, if the target position is not located on the displayed map, creates another map in which the target position is matched with the predefined position using the stored map data, and replaces the currently displayed map with the created map.
